(19) United States
(12) Patent Application Publication
(10) Pub. No.: US 2010/0070535 A1
(43) Pub. Date: Mar. 18, 2010

(54) DATA SCHEMA TRANSFORMATION USING DECLARATIVE TRANSFORMATIONS

(75) Inventors: Luis Irun-Briz, Belleview, WA (US); Jose Bernabeu-Auban, Redmond, WA (US); Deepak Agarwal, REDMOND, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/209,821

(22) Filed: Sep. 12, 2008

(51) Int. Cl. G06F 17/30

(52) U.S. Cl. 707/802; 707/E17.055

(57) ABSTRACT

Embodiments of the present invention relate to systems, methods and computer storage media for transforming data defining a first data schema to data defining a second data schema by way of a declarative transformation. The transformation includes identifying data defining the first data schema. A declarative transformation is generated to transform the data defining the first data schema to data defining the second data schema. The declarative transformation additionally transforms data instantiated in the first data schema into a data structure of the second data schema. The declarative transformation is generated prior to the second data schema being defined. The declarative transformation, in an embodiment, is utilized to generate the second data schema. The data is transformed utilizing a migration code that is derived from the declarative transformation. In an exemplary embodiment, the declarative transformation is expressed in textual form by a person, and/or utilizing a graphical computer application.

### BACKGROUND

Typically computer applications manage and store data in order to perform functions for which the computer application was developed. During the operation of the computer application, the data is manipulated by the computer application. In order for the computer application to manipulate and persist the data, the data is structured in a data schema defined by one of several paradigms. When the computer application evolves to a later version, the data previously instantiated in a data schema of the earlier version of the computer application typically cannot be manipulated by the later version.

Traditionally, a developer creates a new data schema that serves as a blueprint for the developer to write a transformation code to transform data to a new schema. The creation of the new data schema is a developmental step that requires resources of the developer. The new data schema is then utilized to aid the developer in writing a transformation code that transforms data instantiated in the earlier data schema to data that the evolved computer application is able to manipulate. The writing of the transformation code is prone to errors as a result of the developer having to account for any possible data schema instantiation. The transformation code therefore requires testing to ensure a valid transformation of the data will result.

### SUMMARY

Embodiments of the present invention relate to systems, methods and computer storage media for transforming data defining a first data schema to data defining a second data schema by way of a declarative transformation. The transformation includes identifying data defining the first data schema. A declarative transformation is generated to transform the data defining the first data schema to data defining the second data schema. The declarative transformation is generated prior to the second data schema being defined. In an embodiment, the declarative transformation is utilized, in part, to generate the second data schema. The data defining the first data schema is transformed utilizing a migration code that is derived from the declarative transformation. The transformed data defines the second data schema.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 depicts an exemplary computing device suitable for implementing embodiments of the present invention;

FIG. 2 depicts an environment suitable for implementing embodiments of the present invention for transforming an original data schema to a second data schema by way of a declarative transformation;

FIG. 3 graphically depicts a first data schema and a second data schema associated with an exemplary declarative transformation in accordance with an embodiment of the present invention;

FIG. 4 graphically depicts another first data schema and another second data schema associated with an exemplary declarative transformation in accordance with an embodiment of the present invention;

FIG. 5 depicts an exemplary method of transforming data defining a first data schema to data defining a second data schema by way of a declarative transformation in accordance with an embodiment of the present invention;

FIG. 6 depicts an exemplary method of transforming a first set of data from a first data instantiation of a first data schema to a second set of data of a second data instantiation of a second data schema by way of a declarative transformation in accordance with an embodiment of the present invention; and

FIG. 7 depicts an exemplary method of transforming data defining a first data schema to data defining a second data schema by way of a declarative transformation in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Embodiments of the present invention relate to systems, methods and computer storage media for transforming data defining a first data schema to data defining a second data schema by way of a declarative transformation. The transformation includes identifying data defining the first data schema. A declarative transformation is generated to transform the data defining the first data schema to data defining the second data schema. The declarative transformation is generated prior to the second data schema being defined. The data defining the first data schema is transformed utilizing a migration code that is derived from the declarative transformation. In an embodiment, the declarative transformation is utilized, in part, to automatically generate the second data schema. The transformed data can define the second data schema in an exemplary embodiment.

Accordingly, in one aspect, the present invention provides a method for transforming data defining a first data schema to data defining a second data schema by way of a declarative transformation. The method includes identifying data defining the first data schema. The method also includes generating a declarative transformation to transform the data defining the first data schema to data defining the second data schema. The declarative transformation is generated prior to the second data schema being defined. The method additionally includes transforming the data defining the first data schema utilizing a migration code that is derived from the declarative transformation. The transformed data defines the second data schema.

In another aspect, the present invention provides computer storage media having computer-executable instructions embodied thereon for performing a method for transforming a first set of data from a first data instantiation compatible with a first data schema to a second set of data of a second data instantiation compatible with a second data schema by way of a declarative transformation. The media includes identifying a first set of data of the first data instantiation. The media also includes generating a declarative transformation to transform the first set of data to the second set of data. The declarative transformation is generated prior to the second data schema being defined. The media additionally includes transforming the first set of data from the first data instantiation utilizing a migration code that is derived from the declarative transformation. The transformed first set of data becomes the second set of data.

A third aspect of the present invention provides a method for transforming data defining a first data schema to data defining a second data schema by way of a declarative transformation. The method includes identifying the data defining the first data schema. The first data schema is based on an object-oriented paradigm. Additionally, the first data schema provides a description of one or more classes, properties, and relationships. The method also includes generating a declarative transformation to transform the data defining the first data schema to the data defining the second data schema. The declarative transformation is generated prior to the second data schema being defined by the data defining the second data schema. The declarative transformation includes an indication as to one or more instances to which the declarative transformation applies, an indication as to how one or more classes are transformed, an indication how one or more properties are transformed, and an indication as to how relationships that apply to the first data schema are transformed. The method additionally includes utilizing the declarative transformation to automatically generate a migration code. The method also includes transforming the data defining the first data schema to the data defining the second data schema utilizing the migration code.

Having briefly described an overview of embodiments of the present invention, an exemplary operating environment suitable for implementing embodiments hereof is described below.

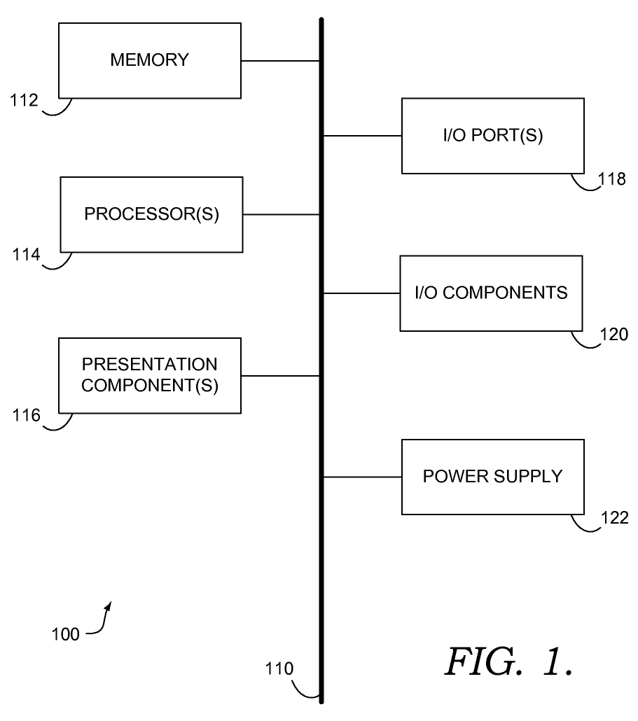

Referring to the drawings in general, and initially to FIG. 1 in particular, an exemplary operating environment suitable for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/components illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks or implements particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier waves or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, and the like. I/O ports 118 allow computing device 100 to be logically coupled to other devices including I/O modules 120, some of which may be built in. Illustrative modules include a microphone, joystick, game pad, satellite dish, scanner, printer, wireless device, and the like.

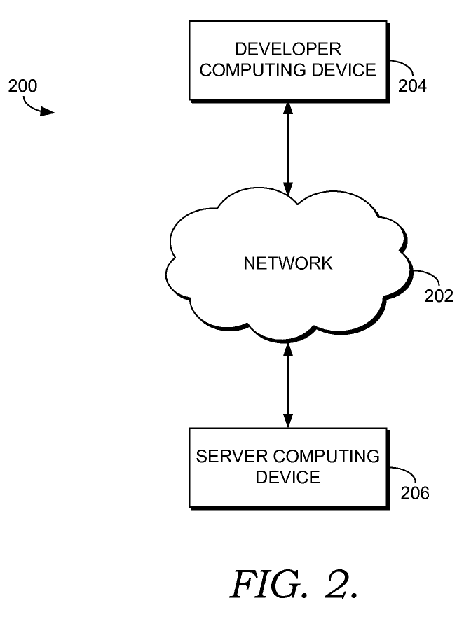

With reference to FIG. 2, which depicts an exemplary environment 200 for transforming an original data schema to a second data schema by way of a declarative transformation. The exemplary environment 200 includes a network 202. The network 202 may include, without limitation, one or more local area networks (LANs) and/or wide area networks (WANs). Such networking environments are commonplace in offices, enterprise-wide computer networks, intranets, and the Internet. Accordingly, the network 202 is not further described herein.

The exemplary environment 200 also includes a developer computing device 204. The developer computing device 204 is a computing device utilized by a developer of a computer application to facilitate the evolution of the computer application and associated data structures. The evolution through various developmental stages of the computer application is initiated through the developer computing device 204. For example, a developer may utilize the developer computing device 204 to alter the data structure of the data the computer application manipulates. Alteration of the data structure is often necessary to allow the computer application to manipulate the data after the computer application has evolved. Typically, computer applications evolve as a result of updates, upgrades, and/or increased resource demands on the computer application. In an exemplary embodiment, the developer computing device 204 is a computing device 100, as previously discussed with reference to FIG. 1.

The exemplary environment 200 also includes a server computing device 206. The server computing device 206 stores and facilitates the manipulation of a computer application and its associated data. In an exemplary embodiment, the server computing device 206 serves a computer application that is accessible by way of the network 202. The computer application evolves, and as a result, the structure of the associated data is also altered to allow the evolved computer application to manipulate the associated data. Therefore, in an exemplary embodiment, a developer utilizes the developer computing device 204 to communicate by way of the network 202 with the server computing device 206. The developer creates a declarative transformation that is applied to the associated data to transform the associated data into a data structure that the computer application can manipulate.

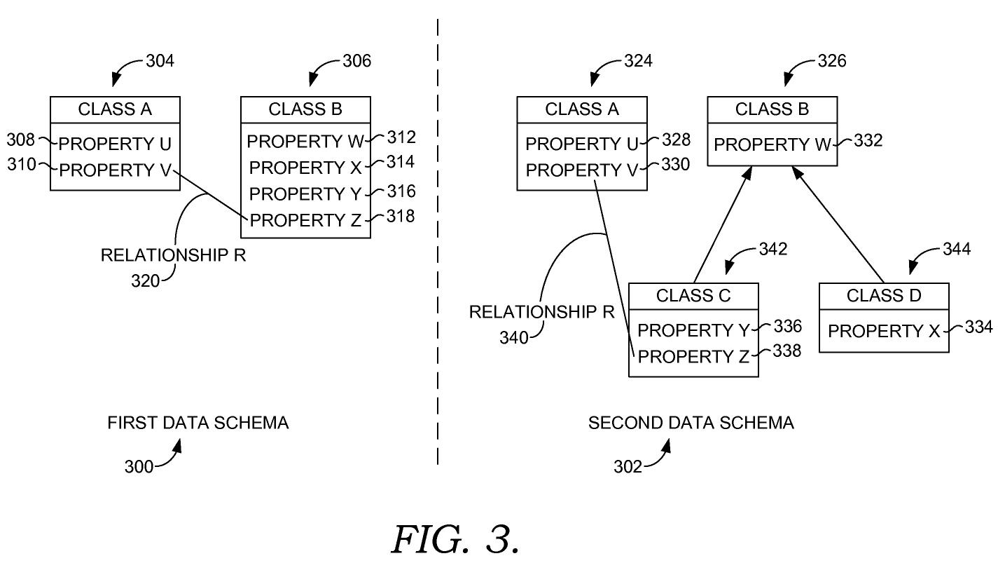

Turning now to FIG. 3, which graphically depicts a first data schema 300 and a second data schema 302 of an exemplary declarative transformation. The second data schema 302 is a transformation of the first data schema 300. For example, when a computer application evolves from a first version (persisting data in the first data schema 300) to a second version, the data must also evolve so that the second version of the computer application can manipulate the existing data. Therefore, the second data schema 302 visually depicts an exemplary data structure that the second version of the computer application is able to manipulate as data. While the following discussion references vocabulary typically associated with object-oriented programming, it is understood that additional programming paradigms are applicable to the present invention. For example, relational data models, such as data models compatible with relational database management systems (RDBMS), can be transformed by way of a declarative transformation.

The first data schema 300 includes a Class A 304 and a Class B 306. A class is a programming language construct that is used to create objects that share common properties (attributes) and/or methods (verbs). Properties are attributes used to define a property of an object or element. A method is an action that can be taken against an object or an element. Additionally, the object-oriented paradigm includes building blocks other than classes and properties. For example, additional building blocks include methods, also referred to as verbs, which are actions that can be taken against an object or other element.

A specific instantiation of an object or a class is referred to as an instance. An example of the connection among a class and an instance includes a class of “DOG,” which includes a number of properties, such as breed and color. A particular instance of the class DOG is Rover, where Rover is a specific dog that has properties of black in color and Labrador in breed. As a result, Rover is an instance of DOG. Additionally, the interaction among various classes are described by relationships that explain how classes are related.

Typically, a computer application (application) utilizes data that is manipulated by the application. The application persists the data between instantiations. But, when the application changes, such as evolving to a subsequent version, the new version of the application must handle the data persisted by the former version. Traditionally, an adaptation algorithm transforms the data persisted by the previous version to a data schema useable by the new version of the application. The adaptation is implemented as a set of actions, which includes algorithms that move the objects existing in the original schema into a corresponding object in a new data schema. Depending on the change from the original schema to the new schema, the algorithm can become very complex and prone to errors. Examples of changes that can be performed when adapting data of the original schema to the new schema include, but are not limited to: adding or removing properties of the classes, adding or removing classes, adding or removing relationships between classes, grouping multiple classes into inheritance trees, aggregating classes through the merging of the class properties into a single class, segregating classes by identifying relationships, calculating properties based on derivatives of other fields, changing semantic constraints, and changing the visibility of names of roles.

The adaptation algorithm is traditionally created by a developer that has knowledge and understanding of the original data schema and the new data schema. Typically, the developer must also know the capabilities to instantiate and destroy objects in both the original data schema and the new data schema. Also, the developer must know of the capabilities of copying data between the original data schema and the new data schema. Additionally, the developer must know of the capabilities to correlate instances among schemas that represent the same object in order to reconstruct the relationships. The above listed restriction and requirements make an adaptation algorithm difficult to successfully implement because of poor reconstructions of properties, poor reconstruction of relationships, poor reconstructions of inheritance, failure to consider constraints in the new data schema that did not exist in the original data schema, lost properties in the new data schema, and breaks in consistency of mutual association. Therefore, replacement of the adaptation algorithm with a declarative transformation allows for the data persisted in the original data schema to be manipulated in the new schema, without the complexities of the adaptation algorithm.

A declarative transformation, in an exemplary embodiment, utilizes the original schema definition as an input. The declarative transformation then applies a set of transformation declarations, each of which describes how the new data schema differs from the original data schema. The declarative transformation then produces as an output, which is the definition of the new data schema. In an additional exemplary embodiment, the declarative transformation receives an instantiation of data from the original data schema, and as an output, produces an instantiation according to the new data schema.

An exemplary declarative transformation includes an identification as to which instances the transformation applies, how the classes are transformed, how the affected instances are transformed, and how the relationships of the original data schema are transformed. Therefore, an exemplary declarative transformation satisfies that an instantiation of the new data schema will not have constraint violations. Also, an exemplary transformation ensures that the old data schema instantiation does not include untransformed objects and the new schema instantiation satisfies the output definition of a transformed computer application.

The following includes a listing of exemplary transformations that can be utilized when transforming data persisted by an original data schema to a new data schema. The following transformations are not limiting as to the scope of the transformation, but instead are merely exemplary transformation. Additionally, declarative transformation can be implemented using several programming paradigms, including imperative and functional paradigms. It is contemplated that additional transformation are utilized to facilitate the declarative transformation from an original data schema to a new data schema. The exemplary transformations include:

### Class Level Transformations

(1) Rename (old name, new name). The rename transformation renames an old class into a new class. Therefore, the instances of the old name are now instances of the new name. In an exemplary embodiment, all of the relationships to the old name are adjusted to the new name.

(2) DeleteInstances(class name, where condition). The delete instances transformation deletes instances of the class that satisfy a given condition. This results in the removal of all relationships in which they are included.

(3) Delete (class name). The delete transformation deletes the given class. In an exemplary embodiment, once a class has been deleted, an instance cannot exist within that class.

(4) Create(class name). The create transformation creates a new class.

(5) SetSuperClass(class name, property defaults). The set super class transformation specifies a super class for a given class. This indicates the property names and default values that are associated with each property within the super class. In an exemplary embodiment, the super class can only be set if the declared class does not already have a super class.

(6) DeleteInheritance( ). The delete inheritance transformation removes an identified inheritance from a given class. In an exemplary embodiment, all of the instances of the class from which the inheritance is to be removed must have default values in all of the inherited properties.

(7) MoveInstances(destination class name, property defaults, where expression). The move instances transformation moves instances that satisfy a given condition from a class to an identified destination class. Additionally, in an exemplary embodiment, the move instances transformation also provides the property name and default values to be given for each property that exists in the destination class and that does not exist the originating class.

### Property Level Transformations.—Class (clname).Properties—

(1) Rename(old name, new name). The rename transformation renames a property from the original property name to a new property name.

(2) Delete(property name). The delete transformation deletes an identified property. In an exemplary embodiment, the value of the identified property is lost for all instances of the class.

(3) Add(property name, type). The add transformation adds a property with an identified type. In an exemplary embodiment, the class to which the properties are added cannot include any instances.

(4) SetToDefault(property name, where condition). The set to default transformation sets a default value for the instance satisfying a given condition.

(5) ChangeType(property name, new type). The change type transformation changes the type of an identified property. In an exemplary embodiment, the class to which the change type transformation is applied cannot include any instances loosing data.

(6) MoveToClass(property name, other class name, destination property name). The move to class transformation moves an identified property from a first class to an identified destination class such that for each instance of the class, the property is moved to each instance of the identified class. In an exemplary embodiment, the property to be moved must have a default value for the instances of the class not linked to any instances of the identified other class name.

### Relationship Transformations—Class(clname).Relationships—

(1) Rename(old name, new name). The rename transformation renames an old relationship with an identified new name.

(2) Add(relationship name, other class, other end arity, this end arity, name on the other class, association type). The add transformation declares a new relationship. The “other end arity” of the transformation indicates the number of instances in the other class that can be related to an instance of the current class (clname). Additionally, the “this end arity” of the transformation indicates how many instances of the current class can be related to an instance of the other class. In an exemplary embodiment, if the “name on the other class” is anything other than “none” the relation is bidirectional. Additionally, in an exemplary embodiment, the “association type” can be an Association, an Aggregation, and a Composition.

(3) MoveToClass(relationship name, other class name, destination relationship name). The move to class transformation moves an identified relationship to an identified class. In an exemplary embodiment, each instance of the current class (clname), the identified relationship is moved to each instance of the “other class name” that is linked to the relationship.

(4) ChangeThisEndArity(relationship name, where expression). The Change this end arity transformation changes the arity of the relationship at the identified end (e.g., the number of instances of the current class that can be related to a single instance in the other class). In an exemplary embodiment, the new arity cannot violate any instances of the current class.

(5) DeleteElements(relationship name, where expression). The delete elements transformation deletes elements from the identified relations that satisfied the given expression. In an exemplary embodiment, if the relationship is bidirectional, the elements are deleted from both ends.

(6) DeleteThisEnd(relationship name). The delete this end transformation removes the end of the relationship associated with the current class. In an exemplary embodiment, the relationship must be empty for all instances in the current class.

(7) MoveElementsToRelationship(other class name, relationship, where expression). The move elements to relationship transformation moves elements from the identified relationship to another relationship when the expression is satisfied. In an exemplary embodiment, each instance of the class, the elements of the relationship are moved to each instance of the “other class name” linked to the relationship.

(8) CopyElementsToRelationship(other class name, relationship, where expression). The copy elements to relationship transformation copies elements from an identified relationship to another relationship when the expression is satisfied. In an exemplary embodiment, each instance of the class, the elements of the relationship are copied to each instance of the “other class name” linked to the relationship.

Returning to FIG. 3, the first data schema 300 includes the Class A 304, which includes two properties, a Property U 308 and a Property V 310. The Class B 306 includes four properties, a Property W 312, a Property X 314, a Property Y 316, and a Property Z 318. Additionally, the first data schema 300 includes a Relationship R 320. The Relationship R 320 signifies a relationship between Class A 304 and Class B 306 by way of Property V 310 and Property Z 318. The collection of the Class A 304, the Class B 306, and the Relationship R 320 visually defines a data schema, the first data schema 300.

The second data schema 302, in an exemplary embodiment, is a visual depiction of a data structure that a new version of a computer application (application) is able to manipulate. Therefore, data that was persisted by the application in an original version, where the original version manipulated data in the first data schema 300, the data can be manipulated as the second data schema 302 by the evolved version of the application.

The second data schema 302 includes classes and properties that correlate to the first data schema 300 such that similarly named elements are referenced by a numeral that is larger by a value of twenty. For example, a Class A 324 is included with the second data schema 302, wherein the Class A 324 is comparable to the Class A 304 of the first data schema 300, a difference of twenty in the reference numbers.

The second data schema 302 also includes a Class B 326, a class C 342, a Class D 344, a Property U 328, a Property V 330, a Property W 332, a Property X 334, a Property Y 336, a Property Z 338, and a Relationship R 340. In an exemplary embodiment, the first data schema 300 is declaratively transformed with the following set of transformations that result in the second data schema 302:
(1) Class.Create(C)
(2) Class.Create (D)
(3) Class(C).SetSuperClass(B)
(4) Class(D).SetSuperClass(B)
(5) Class(B).MoveInstance(C, “a==typeisONE”)
(6) Class(B).MoveInstance(D, “a!=typeisONE”)
(7) Class(B).Properties.MoveToClass(Y,C,Y)
(8) Class(B).Properties.MoveToClass(X,D,X)
(9) Class(B).Relationships.MoveToClass(Z,C,Z)

As a result of the above exemplary set of transformations, the Class B 306 is refracted into sub classes Class C 342 and Class D 344. The Class C 342 is created with the transformation “Class.Create(C).” The Class D 344 is created with the transformation “Class.Create (D).” The Property X 314 is moved from Class B 306 to Class C 342 as the Property X 334 by the transformation “Class(B).Properties.MoveToClass(Y,C,Y).” Similarly, the Property X 314 of Class 306 is moved to Class D 344 as Property X 334 by the transformation “Class(B).Properties.MoveToClass(X,D,X).” Also, the Relationship R 320 that exists between Property V 310 and Property Z 318 is moved as the Relationship R 340 between Property V 330 and Property Z 338 by the transformation “Class(B). Relationships.MoveToClass(Z,C,Z).”

In an exemplary embodiment, a declarative transformation, such as the exemplary declarative transformation above, is created by a developer utilizing the developer computing device 204. The declarative transformation is then compiled as a migration code by either the developer computing device 204 or the server computing device 206. The compiled declarative transformation results in a migration code that is applied to the original data schema, such as the first data schema 300. As a result of the migration code developing the new data schema, the evolved computer application is able to manipulate the data originally persisted in an original data schema, as the new data schema.

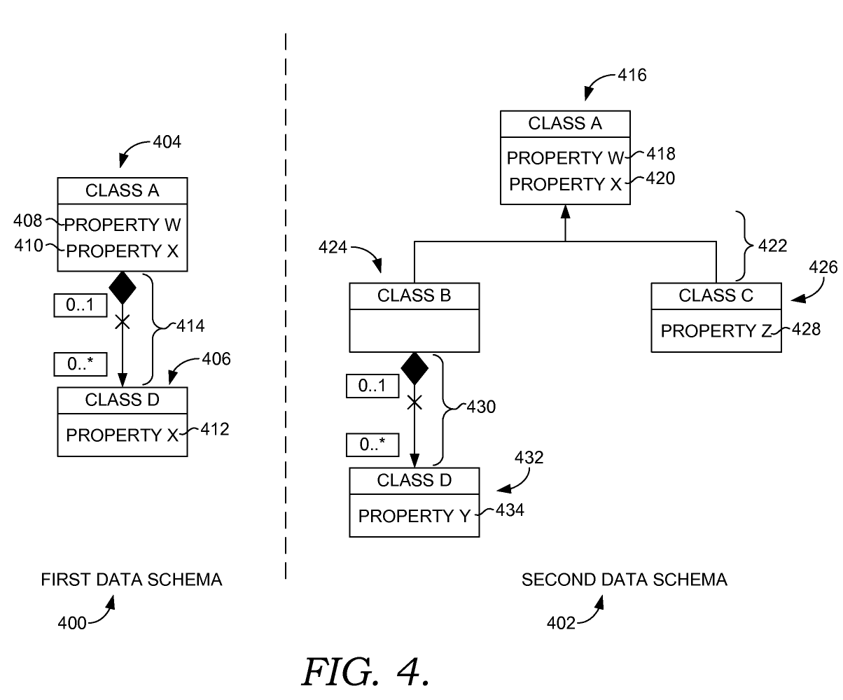

Turning to FIG. 4, which visually depicts a first data schema 400 and a second data schema 402 of an exemplary declarative transformation. The second data schema 402 is a transformation of the first data schema 400.

The first data schema 400 includes a Class A 404 and a Class D 406. The Class A 404 includes a Property W 408 and a Property X 410. The Class D 406 includes a Property Y 412.

Additionally, a relationship 414 exists between the Class A 404 and the Class D 406. The relationship 414 is a unidirectional relationship, as indicated by a relationship arrow directed to Class D 406. The unidirectional nature of relationship 414 means that given a specific instance from Class D 406, it is not generally possible to determine which instances of Class A 404 are related. Further, the relationship 414 is a composition (as indicated by the solid diamond of relationship 414) such that when an instance of Class A 404 is deleted, all instances of Class D 406 related to the deleted instance will also be deleted. Also, in this example the relationship 414 has an arity “0 . . . 1” that indicates that a particular instance of Class D 406 can be part of zero to one instances of Class A 404. The relationship 414 also includes an arity “0 . . . *” that indicates a particular instance of Class A 404 can have zero or more instances of Class D 406.

Traditionally, a computer application will run and result in an instantiation of data in the first data schema 400. The instantiation results in several object instances of Class A 404 and of Class D 406, such that the object instances have specific properties and values. Typically, if the computer application evolves, so would the data schema. For example, the second data schema 402 would be defined and a developer would create a transformation code to transform any possible schema instantiation of the first data schema 400 into the second data schema 402. As previously discussed, the creation of the transformation code by the developer is resource intensive and prone to errors. As a result, it is desirable to automatically develop the transformation code by way of a set of declarative transformation, which, when compiled create the migration code. Therefore, in an exemplary embodiment of the present invention, the second data schema 402 is the result of a set of declarative transformations as opposed to the direct creation of a developer preparing to create a transformation code.

The second data schema 402 includes a Class A 416, a Class B 424, a Class C 426, and a Class D 432. The Class A 416 includes a Property W 418 and a Property X 420. The Properties W 418 and X 420 are similar to the Properties W 408 and X 410 of the first data schema 400. The Class C 426, of the second data schema 402, includes a Property Z 426. The Class D 432 includes a Property Y 434. The Class B 424 and the Class C 426 are sub classes of Class A 416, as indicated by an inherency connector 422. Additionally, a relationship 430 exists between the Class B 424 and the Class D 432. The relationship 430 is bidirectional (as indicated by the absence of an arrow), which indicates given a specific instance of Class D 432 the related instances of Class B 424 are determinable. Additionally, the relationship 430 is a composition. Also, the relationship 430 includes arity “0 . . . 1” which indicates that a particular instance of the Class D 432 can be part of zero or one instances of Class B 424. The relationship 430 also includes an arity “1 . . . *” that indicates that a particular instance of Class B 424 must have at least one instance of Class D 432.

As previously discussed, after a computer application evolves, a developer would typically create a graphical diagram to represent the second data schema 402 before creating a transformation code. The transformation code should transform any possible schema instantiations of the first data schema 400. It is traditionally very difficult to ensure that all possible schema instantiations are covered by the transformation code. If the transformation code fails to account for a possible schema instantiation that was instantiated by the computer application prior to evolving, then that data of that schema instantiation will not be available to the evolved computer application. As a result, a significant amount of testing is required to ensure that all possible schema instantiation are accounted for within the transformation code.

In an exemplary embodiment, as opposed to a developer starting with a second data schema to create a transformation code, the developer begins with a first data schema and transforms the first schema to create the second schema with declarative transformations. Therefore, in an exemplary embodiment, the migration code that transforms the data from the first schema to the second schema is automatically generated based on the declarative transformations.

For example, the first data schema 400 is transformed with the following set of declarative transformations to result in a data schema visually depicted by the second data schema 402.
(1) Class.NewSubclass(Class A, Class C, a: count(414)==0)

a. Class(A).NewSubclass(Class C)

b. Class(A).MovetoClass(Class C, a: count(414)==0)
(2) Class(C).AddAttribute (Property Z, 4)
(3) Class.NewSubClass(Class A, Class B, a: count(414)>0)

a. Class(A).NewSubclass(Class B)

b. Class(A).MoveToClass(Class B, a: count(414)>0)
(4) Class(A).Relationship.MoveToClass(414, Class B, 430)
(5) Class(B).Relationships.MakeRelationshipBidirectional(430)
(6) Class(B).Relationship.ChangeRelationshipArity(430,“1 . . . *”)

The first transformation, “Class.NewSubclass (Class A, Class C, a: count(414)==0,” creates the Class C 426 as a subclass of Class A 416. All instances of Class A 404 that were related to zero instances of Class D 406 moved to the newly created Class C 426. In an additional embodiment, the transformation could alternatively be described as the sequence of transformations “Class(A).NewSubclass(Class C)” creates the subclass Class C 426 as a subclass of Class A 416, and “Class(A).MovetoClass(Class C, a: count(414)==0)” instructs instances of Class A not related through relationship 414 to any instances of Class C to move to Class C.

The second transformation, “Class(C).AddAttribute (Property Z, 4),” adds a property, Property Z 428, to the Class C 426. The default value for Property Z 428 is set as a four.

The third transformation, “Class.NewSubClass(Class A, Class B, a: count(414)>0),” creates the Class B 424 as a subclass of Class A 416. All instances of Class A 404 not moved to Class C 426 (those instances with greater than zero relationships with Class D 406) are moved to the newly created Class B 424. IN an additional embodiment, the transformation could be described in an alternative sequence of transformations. For example, “Class(A).NewSubclass(Class B)” creates the subclass Class B 424 as a subclass of Class A 416, and “Class(A).MoveToClass(Class B, a: count(414)>0)” instructs instances of Class A related by relationship 414 to some instances of Class C to be moved to Class B

The fourth transformation, “Class(A).Relationship.MoveToClass(414, Class B, 430),” moves the relationship 414 from Class A 404 to the Class B 424, as represented by the relationship 430.

The fifth transformation, “Class(B).Relationship.MakeRelationshipBidirectional(430),” makes the relationship 430 a bidirectional relationship as opposed to a unidirectional relationship of the original relationship 414.

The sixth transformation, “Relationship.ChangeRelationshipArity(430, “1 . . . *”),” changes the arity of the relationship 430 to one or greater. This is a change from the relationship 414, which had an arity of zero or greater. This change is a result of those instances that would have satisfied an arity equal to zero being moved to Class C 426 by the first transformation.

In an exemplary embodiment, a developer creates the above set of transformation utilizing the developer computing device 204 of FIG. 2. The set of declarative transformations are then compiled by the developer computing device 204 to create a migration code. The resulting migration code is then applied to the data stored at the server computing device 206 of FIG. 2. The data is persisted in the first data schema 400, but following the transformation that results from the migration code, the data is transformed to the second data schema 402. Data in a structure of the second data schema 402 can be manipulated by a computer application that has evolved.

It is understood by those with ordinary skill in the art that the above exemplary transformation is merely an example and not intended to be limiting on the scope of the present invention. For example, while a particular syntax is discussed in the above examples, the syntax of the present invention is not limited to examples provided herein. Additionally, the limited declarations provided in the above examples are not limiting as to the scope of the present invention. To the contrary, the declarations provided as mere examples are understood by those with ordinary skill in the art to illustrate, rather than define, the declarations available for the present invention. Therefore, while examples with specific syntax and declarations are provided herein, those examples are not limiting on the scope of the present invention.

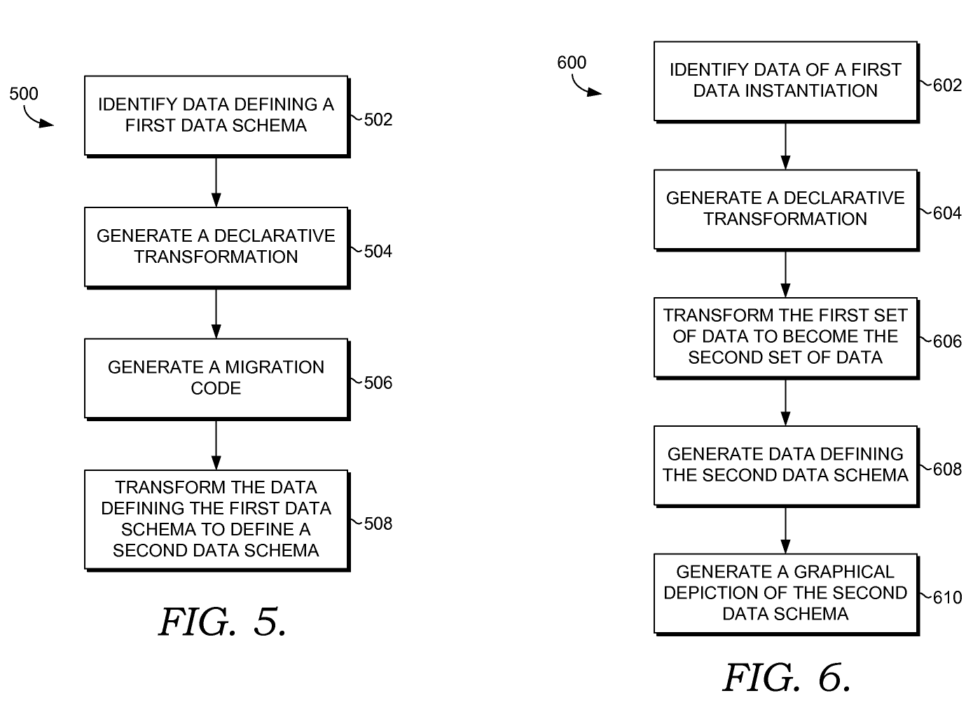

Turning now to FIG. 5, which depicts an exemplary method 500 of transforming data defining a first data schema to data defining a second data schema by way of a declarative transformation, in accordance with an embodiment of the present invention. At a step 502, data defining a first data schema is identified. In an exemplary embodiment, the data defining the first data schema is one or more definition files utilized to structure data persisted by a computer application that manipulates the data. For example, an operating computer application stores instances of the data schema based on the structure defined by the definition files. The definition files essentially describe the association among multiple classes, properties, and relationships. Identification of the data defining the first data schema includes identifying the various elements of the structure, such as the classes, properties, and relationships. As previously discussed, while the exemplary embodiment describes an object-oriented programming paradigm, additional paradigms are applicable, such as relational paradigms.

In an exemplary embodiment, the developer computing device 204 of FIG. 2 identifies the data defining the first data schema. The data stored in the first data schema, in the exemplary embodiment, is maintained at the server computing device 206 of FIG. 2. In an additional exemplary embodiment, the developer identifies the data defining a first data schema as represented at the step 502.

At a step 504, a declarative transformation is generated. The declarative transformation will transform the data identified at the step 502 into a second data schema that a computer application can manipulate. The declarative transformation generated at step 504, in an exemplary embodiment, includes a set of declarative transformations that address multiple elements, such as classes, properties, and relationships in an object-oriented paradigm. In an additional exemplary embodiment, the declarative transformation generated at the step 504 includes multiple declarative transformations that address multiple elements of a relational paradigm. In an exemplary embodiment, regardless of the paradigm to which the declarative transformation are directed, the transformations generated at the step 504 utilize the data identified in the step 502. Additionally, the declarative transformations generated at step 504 are generated without first defining the second data schema.

The declarative transformation generated at step 504, in an exemplary embodiment, includes an indication as to which instances the declarative transformation applies. Additionally, the declarative transformation includes an indication as to how one or more classes are transformed. Also, the declarative transformation includes an indication on how one or more properties are transformed. Further, the declarative transformation, in this exemplary embodiment, includes an indication as to how relationships that apply to the first data schema are transformed. It is understood that any or all of the above-listed indication can be included in a declarative transformation.

In an exemplary embodiment, the declarative transformation generated at the step 504 are generated by a computing device, such as the developer computing device 204 of FIG. 2. In an additional exemplary embodiment, a developer generates the declarative transformations and enters those declarative transformations into a computing device, such as the developer computing device 204 of FIG. 2. For example, the developer may employ a textual based application or a graphical based application to convey the declarative transformation.

At a step 506, a migration code is generated. The migration code is created from the declarative transformation generated at the step 504. In an exemplary embodiment, the migration code is automatically generated by a computing device, such as the developer computing device 204. For example, the developer using the developer computing device 204 of FIG. 2 enters the transformation into the developer computing device 204. The developer then instructs the developer computing device 204 to generate, either with developer intervention or automatically, the migration code that will transform the data from the first data schema to a resulting second data schema. In an additional exemplary embodiment, the migration code is generated by a developer. The developer, in the exemplary embodiment, utilizes the declarative transformations generated at step 504 to generate the migration code at step 506.

The migration code, in an exemplary embodiment, is created based on the declarative transformation generated at step 504. For example, the declarative transformation is compiled by a computing device into code that is readable by a computing device. The resulting code provides instructions to a computing device to transform the data structured as a first data schema into a structure of a second data schema. Therefore, if a computer application that has persisted data in a first data structure evolves, such as when a new version of the computer application is created, the persisted data is then transformed based on the migration code. It is understood that the use of the term “compile” is not limiting, but instead represents one method for converting the declarative transformation into a form of migration code that is readable by a computing device to transform persisted data.

At a step 508, the data defining the first data schema is transformed to define a second data schema. In an exemplary embodiment, the migration code generate at step 506 is processed by a computing device to cause the transformation of the data. For example, a computing device, such as the server computing device 206 of FIG. 2, stores the data defining the first data schema. The computing device runs the migration code. The running of the migration code instructs the computing device to transform the data defining the first data schema into the second data schema. In an additional exemplary embodiment, a computing device, such as the developer computing device 204 of FIG. 2, runs the migration code to transform the data defining the first data schema to define the second data schema. In yet an additional exemplary embodiment, a developer transforms the data defining the first data schema to define the second data schema. In an additional embodiment, the second data schema is generated from the declarative transformation. Therefore in an exemplary embodiment, both the migration code and the second data schema are generated utilizing the declarative transformation.

Turning now to FIG. 6, which depicts an exemplary method 600 of transforming a first set of data from a first data instantiation of a first data schema to a second set of data of a second data instantiation of a second data schema by way of a declarative transformation. In an exemplary embodiment, the second data schema does not exist prior to the creation of the declarative transformation. Instead, the second data schema is a result of the declarative transformation being applied to the first data schema. For example, the first data schema can be the input from which the declarative transformation is generated. The declarative transformation is then applied to the first data schema to create the second data schema. In an additional exemplary embodiment, the data persisted by a computer application in a first data schema is the input from which a declarative transformation is generated. The declarative transformation can be applied to the persisted data (that is structured under the first data schema) to transform the persisted data into a structure of a second data schema. In this example, the second data schema is not created prior to the generation of the declarative transformation, but instead, the second data schema is determined from the declarative transformation as applied to the persisted data.

At a step 602, data of a first data instantiation is identified. Identification of the data, in an exemplary embodiment, includes a developer locating data that is desired to be transformed or data that is to be manipulated by a computer application that has evolved. In an additional exemplary embodiment, the identification of data of a first data instantiation is identified by a computing device. For example, the developer computing device 204 of FIG. 2 identifies persisted data that will be manipulated by a computer application, where the data was stored in a data schema utilized by a prior version of the computer application. Therefore, in order for the current version of the computer application to manipulate the data, the data must be transformed into a data schema that is compatible with the current version of the computer application. The identification of data of a first data instantiation can be either manual or automatically identified.

At a step 604, a declarative transformation is generated. The declarative transformation can be automatically or manually generated. In an exemplary embodiment, the declarative transformation is generated prior to a second data schema (which is defined in part by the declarative transformation) being defined. As previously discussed, the declarative transformation can be generated by a developer and/or a computing device. The declarative transformation provides a way of updating a data schema declaratively rather than imperatively (i.e., programmatically). In an exemplary embodiment, the declarative transformation is processed by a computing device to generate a migration code. The migration code can be computer readable code that imperatively controls the computing device to transform the data of the schema and/or the data defining the data schema.

At a step 606, a first set of data from a first instantiation is transformed by a migration code. The migration code is created utilizing, in part, the declarative transformation generated at the step 604. In an exemplary embodiment, the migration code is created by a computing device that compiles the declarative transformation into a computer readable format. For example, the computing device takes as an input the declarative transformations generated at step 604 and creates the migration code as an output. The migration code, in this example, is structured similar to a traditional transformation code that would be generated by a developer attempting to transform data from a first schema to a second schema without the aid of declarative transformation (i.e., source code). In an additional example, the migration code is not similar in structure to a traditional transformation code, but instead the migration code is in a computer readable structure that is not traditionally able to be generated by a developer without the aid of a computing device (i.e., object code).

The transforming of the first set of data to become a second set of data at step 606 transforms realized instances that have been persisted by a computer application in the first data schema into a second data schema. Generally, the computer application that persisted the first set of data has evolved, and as a result, the computer application can no longer manipulate the first set of data while structured in the first data schema. Therefore, the first set of data must be transformed from the first data schema to a second data schema. The transformation, in this exemplary embodiment, is achieved by utilizing declarative transformations and creating a migration code that a computing device utilizes to effectuate the transformation. As a result, the data that was realized from the first data schema by a computer application can now be manipulated by the computer application because the data is now structured under a second data schema compatible with the computer application.

At a step 608, data defining the second data schema is generated. The data defining the second data schema differs from the data stored in a structure of the second data schema. For example, the data transformed at the step 606 is data that will be manipulated by a computer application as persisted data of the computer application. The data defining a data schema is a definition on how structure, constraints, and semantics of elements are associated to form a schema or structure of data that can be manipulated by the computer application. The data defining the second data schema, in an exemplary embodiment, is generated by a computing device, such as the developer computing device 204 of FIG. 2. Data defining the second data schema in an exemplary embodiment is textual in nature, such that textual elements are used to define the second data schema. In an additional exemplary embodiment, the data defining the second schema is graphical in nature. Such that graphical representations are utilized to identify the elements, constraints and semantics and their associations.

At a step 610, a graphical depiction of the second data schema is generated. In an exemplary embodiment, the graphical depiction is generated by a developer based on the declarative transformations generated at the step 604. In an additional exemplary embodiment, the graphical depiction is generated by a computing device either automatically or at the request of a developer. For example, the declarative transformations generated at the step 604 are provided as an input to a computing device in addition to the first data schema from which the declarative transformation is based. The computing device utilizes the declarative transformation and the first data schema to generate the graphical depiction of the second data schema. In an exemplary embodiment, the graphical depiction is a visualization similar to that provided in FIG. 4. In particular, the second data schema 402 is a graphical depiction of a data schema that results from a first data schema that is graphically depicted as the first data schema 400. It is understood and appreciated by those with ordinary skill in the art that the graphical depiction generated at the step 610 is not limited the examples provided herein, but instead includes graphical depictions that allow a developer to visualize a data schema in a logical representation. Such logical representations are known to those with ordinary skill in the art.

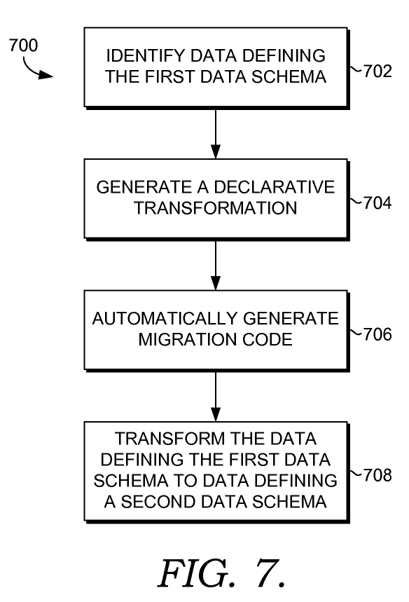

Turning now to FIG. 7, which depicts an exemplary method 700 of transforming data defining a first data schema to data defining a second data schema by way of a declarative transformation. At a step 702, the data defining a first data schema is identified. The data defining a first data schema may be identified by a developer in one exemplary embodiment, or a computing device in another embodiment. The identification of the data defining a first data schema is utilized in an exemplary embodiment as an input to generate a declarative transformation.

At a step 704, a declarative transformation is generated. The declarative transformation provides a blueprint for transforming the data associated with a first data schema or for transforming the data defining a first data schema. Declarative transformations declare how data persisted under a particular programming paradigm should be transformed to remain as viable data to an evolved computer application.

At a step 706, a migration code is automatically generated. The migration code, in an exemplary embodiment is object code that is used by a computing device to transform data defining a data schema. The migration code in another exemplary embodiment is compatible with source code that is later compiled, wherein the resulting code is utilized by a computing device to transform data defining or data stored under a data schema. The migration code is automatically generated by a computing device that utilizes the declarative transformation generated at the step 704 as an input for the resulting migration code. Automatic generation of the migration code from the declarative transformation results in the new data schema instantiations satisfying a data schema utilized by a computer application.

At a step 708, the data defining the first data schema is transformed to data defining a second data schema. For example, when the data identified at the step 702 defines a schema implemented by a computer application as the application is a first version, but then the computer application evolves to a later version, the data defining the data schema must also evolve through a transformation. Therefore, the declarative transformation generated at 704 is utilized to generate a migration code that allows a computing device to transform data defining the first data schema, as represented at the step 708. The transformed data provides a new data schema that satisfies the structure identified by the declarative transformation of step 704.

In an embodiment of the present invention, a declarative transformation is authored by a person. The person may utilize a textual declaration in an embodiment to author the declarative transformation. In an additional embodiment, the person may utilize a graphical tool. It is within the scope of the present invention to utilize any combination of textual declarations and graphical tools to create a declarative transformation.

In an additional embodiment, as previously described, a new schema is automatically generated from a declarative transformation related to a first data schema. Further, in yet an additional embodiment, a migration code is automatically generated from the declarative transformation. The migration code facilitates the migration of instances of first data schema into instances of the new data schema.

Additional embodiments of the present invention include automatically transforming data. The transformation is automatically performed utilizing instances of a first data schema as an input, and as output, utilizing instances of a second data schema. Therefore, a declarative transformation is not required to be created for this embodiment. It is within the scope of the present invention to utilize any combination of instances of the first data schema, instances of the second data schema, and the declarative transformation in order to perform a transformation. For example, a declarative transformation is utilized to generate both a migration code and a second data schema. Therefore, in an embodiment, the declarative transformation is beneficial for generating both the migration code and the second data schema in a related process that allows for a resulting efficient transformation.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A method for transforming data defining a first data schema to data defining a second data schema by way of a declarative transformation, the method comprising:
identifying data defining the first data schema;
generating a declarative transformation to transform the data defining the first data schema to data defining the second data schema, wherein the declarative transformation is generated prior to the second data schema being defined; and
transforming the data defining the first data schema utilizing a migration code that is derived from the declarative transformation, wherein the transformed data defines the second data schema.

2. The method of claim 1, where in the first and the second data schemas are one of either a relation model and an object oriented model.

3. The method of claim 1, wherein a data schema provides a description of one or more different classes, properties, and relationships.

4. The method of claim 1, wherein the declarative transformation identifies the differences between the first data schema and the second data schema.

5. The method of claim 1, wherein the declarative transformation declares how to transform one or more data structures of the first data schema to the second data schema.

6. The method of claim 1, wherein the declarative transformation comprises:
1) an indication as to one or more instances to which the declarative transformation applies;
2) an indication as to how one or more classes are transformed;
3) an indication how one or more properties are transformed; and
4) an indication as to how relationships that apply to the first data schema are transformed.

7. The method of claim 1, wherein the migration code is automatically generated utilizing the declarative transformation.

8. The method of claim 1, wherein the second data schema exists only after the transforming the data defining the first data schema is transformed utilizing the migration code.

9. One or more computer storage media having computer-executable instructions embodied thereon for performing a method for transforming a first set of data from a first data instantiation compatible with a first data schema to a second set of data of a second data instantiation compatible with a second data schema by way of a declarative transformation, the method comprising:
identifying a first set of data of the first data instantiation;
generating a declarative transformation to transform the first set of data to the second set of data, wherein the declarative transformation is generated prior to the second data schema being defined; and
transforming the first set of data from the first data instantiation utilizing a migration code that is derived from the declarative transformation, wherein the transformed first set of data becomes the second set of data.

10. The media of claim 9, wherein the first and second data schemas are one of either a relation model and an object oriented model.

11. The media of claim 9, wherein the first instantiation is a realization of the first data schema that is formed by one or more instances of the realized data schema.

12. The media of claim 9, wherein a data schema provides a description of one or more different classes, properties, and relationships.

13. The media of claim 9, wherein the declarative transformation identifies the differences between the first data schema and the second data schema.

14. The media of claim 9, wherein the declarative transformation declares how to transform the first data set to the second data set.

15. The media of claim 9, wherein the declarative transformation comprises:
1) an indication as to one or more instances to which the declarative transformation applies;
2) an indication as to how one or more classes are transformed;
3) an indication how one or more properties are transformed; and
4) an indication as to how relationships that apply to the first data schema are transformed.

16. The media of claim 9, wherein the migration code is automatically generated utilizing the declarative transformation.

17. The media of claim 9, wherein the second data schema exists only after the first data defining the first data schema is transformed utilizing the migration.

18. The media of claim 9 further comprising generating a definition of the second data schema utilizing the declarative transformation.

19. The media of claim 18 further comprising generating a graphical depiction of the second data schema utilizing the definition of the second data schema.

20. A method for transforming data defining a first data schema to data defining a second data schema by way of a declarative transformation, the method comprising:
identifying the data defining the first data schema, wherein the first data schema is based on an object-oriented paradigm, and wherein the first data schema provides a description of one or more classes, properties, and relationships;
generating a declarative transformation to transform the data defining the first data schema to the data defining the second data schema, wherein the declarative transformation is generated prior to the second data schema being defined by the data defining the second data schema, and
wherein the declarative transformation comprises:
1) an indication as to one or more instances to which the declarative transformation applies;
2) an indication as to how one or more classes are transformed;
3) an indication how one or more properties are transformed; and
4) an indication as to how relationships that apply to the first data schema are transformed;
utilizing the declarative transformation to automatically generate a migration code; and
transforming the data defining the first data schema to the data defining the second data schema utilizing the migration code.
